(19) United States
(12) Patent Application Publication
(10) Pub. No.: US 2024/0357662 A1
(43) Pub. Date: Oct. 24, 2024

(54) ADAPTIVE BACKOFF FOR RANDOM ACCESS CHANNEL

(71) Applicant: NOKIA TECHNOLOGIES OY, Espoo (FI)

(72) Inventors: Samuli Heikki TURTINEN, OULU (FI); Chunli WU, Beijing (CN)

(21) Appl. No.: 18/701,122

(22) PCT Filed: Nov. 8, 2021
(86) PCT No.: PCT/CN2021/129405

§ 371 Date: Apr. 12, 2024

(51) Int. Cl. H04W 74/0833

(52) U.S. Cl. CPC H04W 74/0833

(57) ABSTRACT

Embodiments of the present disclosure relate to methods, devices, apparatuses, and computer readable medium for adaptive backoff for random access channel (RACH). The method comprises: transmitting, at a first device and to a second device, a first message for requesting a first random access to a cell of the second device, resources of the cell being partitioned into a plurality of partitions for a plurality of features, and the first random access associated with a first partition for at least a first feature of the plurality of features; and receiving, from the second device, a second message comprising backoff information corresponding to one of the first feature and the first partition. Since the network is capable of providing backoff applicability information per features or per RACH partitions, the UE using a congested RACH partition can apply backoff in the RA procedure, while accessing of legacy UE or a UE using a RACH partition without congestion would not be affected.

### FIELD

Embodiments of the present disclosure generally relate to the field of telecommunication and in particular, to devices, methods, apparatus and computer readable storage media for adaptive backoff for random access channel (RACH).

### BACKGROUND

With development of communication technology, RACH partitioning is achieved based on various features including, but not limited to Coverage Enhancement (CovEnh), Small Data Transmission (SDT), Reduced Capability (RedCap) and so on. In particular, the RACH partitioning may be achieved by either partitioning the physical random access channel (PRACH) resources or by partitioning preambles associated with a RACh occasion (RO). For the latter case, different preambles of a single RO are mapped to different features.

In the RACH procedure, a backoff indicator (BI) in a random access response (RAR) or a message B (MSGB) indicates backoff to be applied for the RACH RO. In a case that multiple RACH partitions are configured for a certain RO which share the same RA-RNTI/MSGB-RNTI for RAR/MSGB reception, the BI would make all the UEs to backoff, regardless of whether a particular RACH partition is congested or not or whether the UE is a legacy UE not supporting the features. Hence, there is a need for performing an adaptive backoff per RACH partitions.

### SUMMARY

In general, example embodiments of the present disclosure provide a solution for adaptive backoff for RACH.

In a first aspect, there is provided a first device. The first device comprises: at least one processor; and at least one memory including computer program codes. The at least one memory and the computer program codes are configured to, with the at least one processor, cause the first device to: transmit, to a second device, a first message for requesting a first random access to a cell of the second device, resources of the cell being partitioned into a plurality of partitions for a plurality of features, and the first random access associated with a first partition for at least a first feature of the plurality of features; and receive, from the second device, a second message comprising backoff information corresponding to one of the first feature and the first partition.

In a second aspect, there is provided a second device. The second device comprises: at least one processor; and at least one memory including computer program codes. The at least one memory and the computer program codes are configured to, with the at least one processor, cause the second device to: receive, from a first device, a first message for requesting a first random access to a cell of the second device, resources of the cell being partitioned into a plurality of partitions for a plurality of features, and the first random access associated with a first partition for at least a first feature of the plurality of features; and transmit, to the first device, a second message comprising backoff information corresponding to one of the first feature and the first partition.

In a third aspect, there is provided a method. The method comprises: transmitting, at a first device and to a second device, a first message for requesting a first random access to a cell of the second device, resources of the cell being partitioned into a plurality of partitions for a plurality of features, and the first random access associated with a first partition for at least a first feature of the plurality of features; and receiving, from the second device, a second message comprising backoff information corresponding to one of the first feature and the first partition.

In a fourth aspect, there is provided a method. The method comprises: receiving, at a second device and from a first device, a first message for requesting a first random access to a cell of the second device, resources of the cell being partitioned into a plurality of partitions for a plurality of features, and the first random access associated with a first partition for at least a first feature of the plurality of feature; and transmitting, to the first device, a second message comprising backoff information corresponding to one of the first feature and the first partition.

In a fifth aspect, there is provided a first apparatus. The first apparatus comprises: means for transmitting, to a second apparatus, a first message for requesting a first random access to a cell of the second apparatus, resources of the cell being partitioned into a plurality of partitions for a plurality of features, and the first random access associated with a first partition for at least a first feature of the plurality of features; and means for receiving, from the second apparatus, a second message comprising backoff information corresponding to one of the first feature and the first partition.

In a sixth aspect, there is provided a second apparatus. The second apparatus comprises: means for receiving, from a first apparatus, a first message for requesting a first random access to a cell of the second apparatus, resources of the cell being partitioned into a plurality of partitions for a plurality of features, and the first random access associated with a first partition for at least a first feature of the plurality of features; and transmitting, to the first apparatus, a second message comprising backoff information corresponding to one of the first feature and the first partition.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a signaling chart illustrating an example random access procedure according to some example embodiments of the present disclosure;

FIG. 3 is a schematic diagram illustrating an example RACH partitioning according to some example embodiments of the present disclosure;

FIG. 4A is a schematic diagram illustrating an example MAC sub-header according to some example embodiments of the present disclosure;

FIG. 4B is a schematic diagram illustrating another example MAC sub-header according to some example embodiments of the present disclosure;

FIG. 5 illustrates a flowchart of an example method implemented at a first device according to example embodiments of the present disclosure;

FIG. 6 illustrates a flowchart of an example method implemented at a second device according to example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In order to trade off communication requirements with limited resources, different features are preconfigured for different communication requirements. Accordingly, the RACH may be preconfigured for the different communication features, which is shown in table 1 below.

TABLE 1
Example configurations of features

| Feature | Reason for RACH indication |
|---|---|
| RedCap | To indicate reduced capabilities to the network in MSG1 so that |
| | the network can adapt subsequent transmissions |
| SDT | To request a larger MSG3 size (or MSGA size in case of 2-step |
| | RA) and to indicate SDT procedure. |
| CovEnh | To indicate need for coverage enhancement (esp. for request of |
| | MSG3 repetition) |
| Slicing | To indicate high priority slice to the network and to achieve slice |
| | isolation also for RACH |

A UE may support one or more of the features, and thereby the UE may use a RACH partition corresponding to the one or more features. Note that, not all the UEs support the features, and the UE not supporting the features may refer to legacy UEs.

PRACH resources refer to time/frequency resources for RACH, which are the so called RACH occasions (ROs). As previously mentioned, RACH partitioning can either be achieved by partitioning PRACH resources, i.e. different RACH occasions are mapped to different features, or by partitioning preambles associated with the same RO, i.e., a plurality of preambles of the same RO are mapped to different features or feature groups/combination. For example, a feature group/combination may comprise a plurality of different features, such as, RedCap and SDT; RedCap and CovEnh; RedCap and slicing; SDT and CovEnh; SDT and slicing; CovEnh and slicing; RedCap and SDT and CovEnh; RedCap and SDT and slicing; RedCap and CovEnh and slicing; SDT and CovEnh and slicing; RedCap and SDT and CovEnh and slicing; etc.

The feature and/or a feature combination specific preambles can be defined in:
a) separate time/frequency resources, not defined through legacy RRC signalling,
b) within the contention free preamble resources (i.e., within the preambles not used for contention based) defined through legacy RRC signaling, and
c) within the “not available” preambles defined at the end of a RO through the legacy totalNumberOfRA-Preambles.

The BI used in a conventional RA procedure indicates backoff for the RACH RO. When multiple RACH partitions are configured for a certain RO which share the same RA-RNTI/MSGB-RNTI for RAR/MSGB reception, the BI would make all the UEs to backoff regardless of the used RACH partitions even if the congestion is valid only for a certain RACH partition.

From the perspective of gNB, this is problematic for a case where all the UEs perform backoff, however only one or more certain RACH partitions are congested and need to backoff. On the other hand, the RA procedure for UEs using RACH partitions that does not encounter a congestion situation will unnecessarily prolong.

In order to solve the above and other potential problems, embodiments of the present disclosure provide an adaptive backoff mechanism for RACH. According to the adaptive backoff mechanism, a gNB is able to provide BI applicability information per features or per RACH partitions. The BI applicability information is suitable for a RO with or without a common RACH. The BI applicability information may be signaled in any of a RAR for a 4-step RA procedure, a MSGB for a 2-step RA procedure, or a DCI for scheduling the RAR/MSGB. In this way, the UE can determine whether to apply backoff based on a congestion status of the used RACH partition, a specific feature and so on.

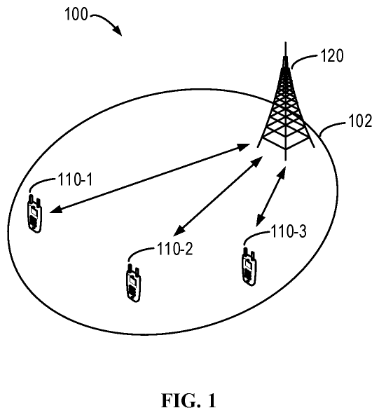

FIG. 1 illustrates an example network environment 100 in which embodiments of the present disclosure can be implemented. The network environment 100, which may be a part of a communication network, comprises first devices 110-1 to 110-3 and a second device 120.

The first devices 110-1 and 110-3 may be implemented as terminal devices, which may be also referred to as terminal devices 110-1 to 110-3, or collectively referred to as first device 110 hereinafter. The second device 120 may be implemented as a network device (such as, a gNB), which may be also referred to as the network device 120 or the gNB 120 hereinafter.

As shown in FIG. 1, the second device 120 provides radio coverage to the first devices 110-1 to 110-3 in a cell 102. The first devices 110-1 to 110-3 may communicate with the second device 120 via uplink and downlink. In particular, the direction from the first device 110 to the second device 120 may refer to uplink (UL), and the direction from the second device 120 to the first device 120 may refer to downlink (DL).

It should be understood that, for the illustrative purpose, in the descriptions of the example embodiments, the first device 110 is given as a UE, and the second device 120 is given as a gNB. However, the first device 110 and the second device 120 can be implemented as any other devices. For example, the first device 110 may be a sensor, a meter, and so on.

It is also to be understood that the number of the devices as shown in FIG. 1 is given only for illustrative purpose without suggesting any limitations. For example, the network environment 100 may include any suitable number of terminal devices and network devices adapted for implementing embodiments of the present disclosure. The present disclosure is not limited in these regards.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), a future sixth generation (6G) and/or any further communication protocols.

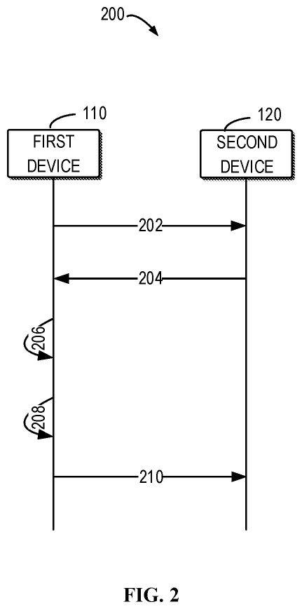

Principle and implementations of the present disclosure will be described in detail below with reference to FIGS. 2 to 4B. FIG. 2 illustrates a signaling chart illustrating an example random access procedure 200 according to some example embodiments of the present disclosure. For the purpose of discussion, the process 200 will be described with reference to FIG. 1. The process 200 may involve the first devices 110-1 to 110-3 and the second device 120.

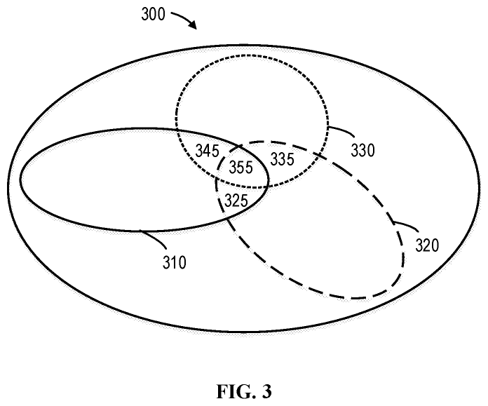

In the process 200, the resources of the cell 102 may be partitioned into a plurality of RACH partitions for a plurality of features, such as, RedCap, SDT, CovEnh, slicing, etc., or for a plurality of feature groups, such as, RedCap/SDT, RedCap/CovEnh, RedCap/slicing, SDT/CovEnh, SDT/slicing, CovEnh/slicing, RedCap/SDT/CovEnh, RedCap/SDT/slicing, RedCap/CovEnh/slicing, SDT/CovEnh/slicing, RedCap/SDT/CovEnh/slicing etc. FIG. 3 is a schematic diagram illustrating an example RACH partitioning 300 according to some example embodiments of the present disclosure. For the purpose of discussion, the example RACH partitioning 300 will be described with reference to FIG. 1.

As shown in FIG. 3, resources of the cell 102 are partitioned into a partition 310 for feature 1 (e.g., RedCap), a partition 320 for feature 2 (e.g., SDT), a partition 330 for feature 3 (e.g., slicing), a partition 325 for a combination of features 1 and 2, a partition 345 for a combination of features 1 and 3, a partition 335 for a combination of features 2 and 3, and a partition 355 for a combination of features 1 and 2 and 3.

It is to be understood that the number of features and the RACH partitions is given for illustrative purpose; the second device 120 may reserve resources for any other features, or partition the resources into more or less RACH partitions. Moreover, as the number of features and RACH partitions increases or decreases, the combination of features may be also changed. The present disclosure is not limited in this regards.

The resources for the features 1 to 3 may overlap with each other, for example, the partitions 325, 335, 345 and 355. The first device 110 may support at least one of the plurality of features 1 to 3 and may use a corresponding one of partitions 310 to 355 for the at least one feature or feature groups/combination. Additionally or alternatively, the first device 110 may be a legacy UE that does not support features 1 to 3. By way of example, the first device 110-1 may support only feature 1 and use partition 310, the first device 110-2 may support features 2 and 3 and use partition 335, and the first device 110-3 may be a legacy UE, and thus use the resources other than those reserved for features 1 to 3. By way of another example, the first device 110 may support all the features 1 to 3, and the RA procedure may be started for features 1 and 3, and in this case, the first device 110 can only use the partition for the features 1 and 3. In other words, only the features that are used for the RA procedure are accounted for the RACH partition selection. By way of another example, the first device 110 may support all the features 1 to 3, and the RA procedure may be started for features 1 and 3, and in this case, the first device 110 can only use the partition associated with both of the features 1 and 3, i.e., may not use other partitions associated with features 1 or 3. In some example embodiments, the RACH partitioning 300 is achieved by partitioning preambles associated with a RO (e.g., 64 preambles per RO). That is, different preambles of a single RO are mapped to different features 1 to 3. For example, preamble indexes 1 to 30 may correspond to feature 1, preamble indexes 15 to 40 may correspond to feature 2, and preamble indexes 25 to 50 may correspond to feature 3, with preamble indexes 15 to 25 corresponding to a combination of features 1 to 2, preamble indexes 30 to 40 corresponding to a combination of features 2 to 3, preamble indexes 25 to 30 corresponding to a combination of features 1 to 3. For example, preamble indexes 1 to 14 may correspond to feature 1, preamble indexes 15 to 24 may correspond to feature 2, preamble indexes 25 to 39 may correspond to feature 3, preamble indexes 40 to 47 corresponding to a combination of features 1 to 2, preamble indexes 48 to 53 corresponding to a combination of features 2 to 3, preamble indexes 54 to 64 corresponding to a combination of features 1 to 3 (ie. features 1 and 2 and 3).

The indexing of RACH partitions may be preconfigured by the second device 120 via a RRC signaling. For example, the second device 120 may transmit a RACH configuration including indexing information of the RACH partitions to the first device 110.

Alternatively, the indexing of the RACH partitions may be based on predetermined rules, including but not limited to:
an ascending order of preamble indexes for the RO,
a descending order of the preamble indexes for the RO,
an ascending order of the features 1 to 3 predetermined for the RO,
a descending order of the features 1 to 3 predetermined for the RO,
an ascending order of the features 1 to 3 configured in the RRC configuration, and
a descending order of the features 1 to 3 configured in the RRC configuration.

To initialize the RA procedure, the first device 110 transmits 202 a first message for requesting a RA to the cell 102 of the second device 120. The RA may be associated with any of features 1 to 3, or alternatively, the RA may not use the feature specific RACH partitions.

In case where only the UEs using the feature specific RACH partitions (e.g., first devices 110-1 and 110-2) transmit preambles to the second device 120, the RACH partitions are configured in the same RO without a common RACH. In another case where both the UEs using the feature specific RACH partitions and legacy UEs and/or the UEs not using the feature specific RACH partitions (e.g., first devices 110-1 to 110-3) transmit preambles to the second device 120, the RACH partitions are configured in the same RO with the common RACH.

In a case of 2-step RA procedure, the first message may be MSGA including RA preamble and data transmissions. In a case of 4-step RA procedure, the first message may be the RA preamble.

Upon receipt of the preamble from the first device 110, the second device 120 needs to indicate whether to apply backoff per RACH partitions. In response to the first message, the second device 120 generates a second message comprising backoff information per RACH partitions. Then, the second device 120 transmits 204 the second message to the first device 110.

The first device 110 determines 206 whether to apply backoff based on the backoff information corresponding to at least one features or RACH partition used by the first device 110. If the backoff information indicates that backoff is applicable to at least one feature or RACH partition used by the first device 110, the first device 110 may apply 208 backoff for a partition for the at least one feature. Otherwise, if the backoff information indicates that backoff is not applicable to the features or RACH partition used by the first device 110, the first device 110 may continue to perform 210 the RA procedure by using the partition for the features.

In the case of the common RACH, BI subheader is provided in the beginning of a MAC PDU. Since the BI subheader may affect all the first devices 110-1 to 110-3 regardless of whether backoff is necessary for the partitions used by first devices 110-1 and 110-2. In this case, backoff information is provided to indicate a BI applicability per RACH partitions.

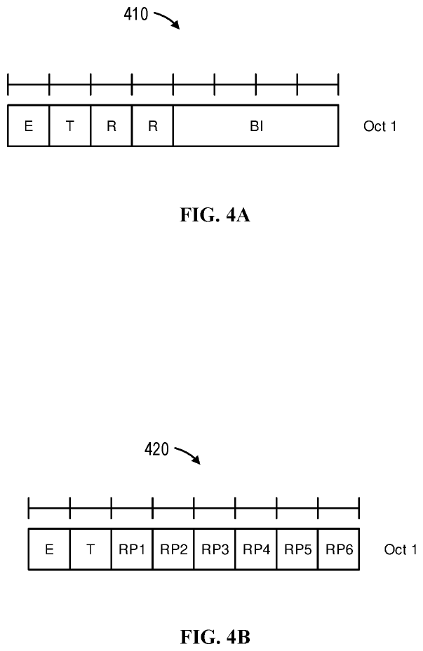

In some example embodiments, the second message may be the RAR for case of 4-step RA procedure or alternatively, the MSGB including the RAR for case of 2-step RA procedure. In these embodiments, the BI applicability is signaled in the RAR/MSGB to indicate for each of the used RACH partitions 310 and 335. FIG. 4A is a schematic diagram illustrating an example MAC sub-header 310 according to some example embodiments of the present disclosure. As shown in FIG. 4A, at least reserved field, i.e., R field in the BI subheader may be used for indicating the BI applicability. For another example, the BI applicability per RACH partition may be provided in a new subheader that is present after all the RARs in the RAR MAC PDU, and one of the R fields in the BI subheader may be used for indicating the presence of the new subheader. As such, the legacy UE or the UE not using feature specific RACH partitions may ignore the new subheader for BI applicability and apply backoff as indicated by BI. On the other hand, the UE using a feature specific RACH partition may determine whether to apply backoff based on the BI applicability information corresponding to the used feature as indicated in the new subheader.

In some other example embodiments, the BI applicability may be provided in downlink control information (DCI) for scheduling the RAR/MSGB. In these embodiments, at least one reserved field in the DCI may be used for indicating the BI applicability. Based on the the BI applicability provided in the DCI and the BI in the RAR/MSGB, the first device 110 may determine whether to apply backoff.

In the case of the RO is not shared with a common RACH, for example, the RO is used by only the first devices 110-1 and 110-2, the backoff information may be BIs per RACH partitions 310 to 355. In this case, the second message may be a RAR or a MSGB that includes BI subheaders per RACH partitions 310 to 355, which may also refer to as partition specific BI subheader. In some example embodiments, the BI subheaders per RACH partition may be present at any position in the RAR/MSGB MAC PDU. In some other example embodiments, all of the BI subheaders may be present at the beginning or at the end of the RAR/MSGB MAC PDU. The present disclosure is not limited in this regard.

For the partition specific BI subheaders, two reserved bits, i.e., R fields may be combined for indicating 4 indexes and each of the indexes may point to one or more RACH partitions. The indexes may be configured via RRC signaling, for example, an index for the RACH partition(s) for which the BI subheader applies. As previously mentioned, the indexing of the RACH partitions may be explicitly configured by the second device 120 via RRC signaling, for example, in the RACH configuration. Additionally or alternatively, the indexing of the RACH partitions may be implicitly determined by the first device 110 based on the RACH partition position in the RACH (e.g., based on ascending or descending order of preamble indexes, RACH partitions per RO, and etc.).

In some example embodiments, only one BI subheader is included in the RAR/MSGB, no matter whether the RO is shared with the common RACH. In these embodiments, the second message may be the RAR/MSGB and the BI subheader is present at the beginning of the RAR/MSGB MAC PDU. The backoff information indicates the BI applicability per RACH partition 310 to 355, which may be provided after all the RARs in the RAR/MSGB MAC PDU.

In the above embodiments, the backoff information may be indicated by using the T field of the MAC RAR subheader. The T field may indicate a presence of a new subheader or field that indicates the BI applicability for each of the RACH partitions 310 to 355. The new subheader may be in the format of bitmap indicating BI applicability for each or a group of RACH partitions 310 to 355. For example, the backoff information indicated by using the T field of the MAC RAR subheader may be placed after the first MAC subheader in the MAC PDU, i.e., after the MAC subheader comprising the BI.

FIG. 4B is a schematic diagram illustrating another example MAC sub-header 420 according to some example embodiments of the present disclosure. As shown in FIG. 4B, the bitmap may include 6 bits to keep a size of the subheader within one byte, and each of RP1 to RP6 fields corresponds to one or more RACH partitions 310 to 355 which may be indexed as described above. Alternatively, in some embodiments, the bitmap may include 14 bits to allow future extensions of different RACH partitions. It should be understood that, the length of the bitmap may not be fixed, but may be determined based on the number of RACH partitions configured in the cell 102 or in the RO that is used for the RA. The present disclosure is not limited in this regard.

The example embodiments of the present disclosure provide an improved backoff mechanism for RACH. In the backoff mechanism, the network is able to provide BI applicability per RACH partitions. Additionally, or alternatively, the network supports indicating RACH partition specific BI. As such, the UE can adaptively apply the backoff based on the congestion status, features and so on. In this way, the network is allowed to indicate backoff only to UEs using a certain RACH partition that is congested without affecting the UEs accessing via a different and not congested RACH partition.

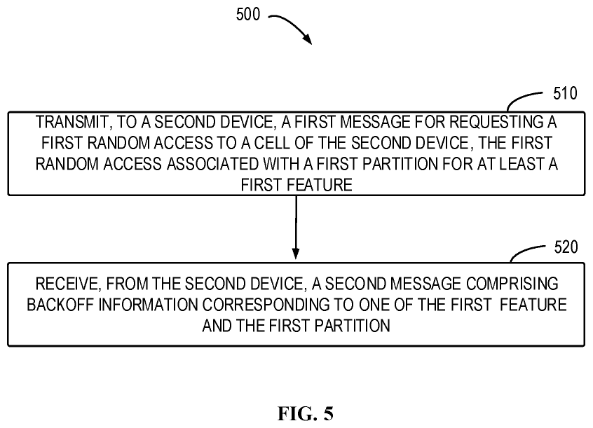

FIG. 5 illustrates a flowchart of an example method 500 implemented at a first device according to example embodiments of the present disclosure. The method 500 can be implemented by a terminal device (e.g., UE), for example, the first device 110 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

At 510, the first device 110 transmits, to the second device 120, a first message for requesting a first random access to a cell of the second device. The resources of the cell 102 are partitioned into a plurality of partitions for a plurality of features, and the first random access is associated with a first partition for at least a first feature of the plurality of features.

At 520, the first device 110 receives, from the second device 120, a second message comprising backoff information corresponding to one of the first feature or the first partition.

The backoff information may indicate a backoff indicator (BI) applicability per feature or per partition, and the BI may be associated with a random access channel occasion (RO) for the plurality of features.

In some example embodiments, the backoff information may be contained in the BI.

In some example embodiments, the second message may further comprise random access responses for the plurality of features, and the backoff information is placed after all the random access responses.

In some example embodiments, a presence of the backoff information may be indicated by one of the following:
at least one reserved bit in a MAC subheader comprising the BI,
at least one reserved field in the second message, and
at least one field in the MAC subheader.

In some example embodiments, the first device 110 may receive, from the second device 120, control information for scheduling the second message. The control information may indicate the presence of the backoff information. The control information may be, for example, the downlink control information (DCI).

In some example embodiments, the backoff information may comprise a bitmap indicating BI applicability for one of the following:
each of the plurality of the features, and
at least one of the plurality of the features for which the backoff applies.

In some example embodiments, the backoff information may comprise a BI corresponding to one of the first feature and the first partition, and the second message may comprise a respective BI per feature or per partition.

In some example embodiments, the backoff information may indicate at least one index of at least one partition for which the backoff applies.

In some example embodiments, the first device 110 may receive, from the second device 120, a random access configuration comprising indexing information of the plurality of features.

In some example embodiments, indexing of the plurality of features is preconfigured by the second device based on one of the following:
an ascending order of preamble indexes for a random access channel, RACH, occasion for the plurality of features, each of the preamble indexes corresponding to a respective one of the plurality of features,
a descending order of the preamble indexes for the RACH occasion,
an ascending order of the plurality of features predetermined for the RACH occasion, and
a descending order of the plurality of features predetermined for the RACH occasion.

In some example embodiments, the first device 110 may determine whether to apply backoff for a partition for the first feature based on the backoff information. For example, if the backoff information indicates that a backoff is applicable to the partition, the first device 110 may perform a backoff for the partition for the first feature. Otherwise, if the backoff information indicates that a backoff is not applicable to the partition, the first device 110 may continue to perform the random access procedure with the second device 120.

In some example embodiments, the first message may comprise a MSGA, and the second message may comprise a MSGB.

In some example embodiments, the first message may comprise a random access preamble, and the second message may comprise a random access response, RAR.

In some example embodiments, the second message may comprise control information for scheduling a response message for the first message.

In some example embodiments, the plurality of features may comprise at least one of coverage enhancement, small data transmission, reduced capability, and slicing.

In some example embodiments, the first device 110 may comprise a terminal device, and the second device 120 may comprise a network device.

According to the example embodiments, there is provided an adaptive backoff mechanism for RACH. Based on the backoff mechanism, applicability information of the BI is provided per feature or per RACH partition. Additionally, or alternatively, the network is capable of indicating RACH partition specific BIs. As such, even the RACH partitions are configured in the same RO(s) with a common RACH, the UE can determine whether to apply backoff from the applicability information. In this way, it may avoid making all the UEs to backoff by the BI, regardless of whether each of the RACH partitions is congested or not, or whether the UE is a legacy UE or not.

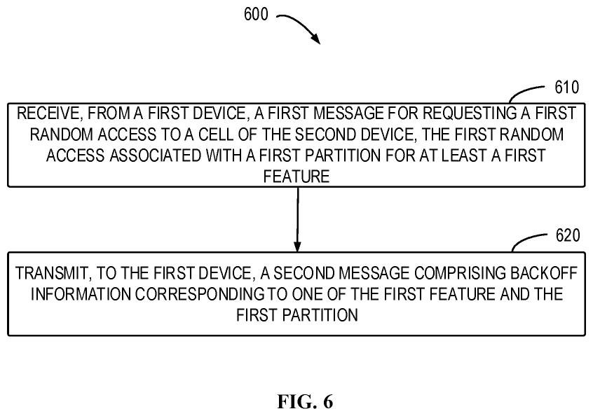

FIG. 6 illustrates a flowchart of an example method 600 implemented at a second device according to example embodiments of the present disclosure. The method 600 can be implemented by a base station or gNB, such as, the second device 120 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

At 610, the second device 120 receives, from the first device 110, a first message for requesting a first random access to the cell 102 of the second device 120. Resources of the cell 102 are partitioned into a plurality of partitions for a plurality of features, and the first random access is associated with a first partition for at least a first feature of the plurality of features.

At 620, the second device 120 transmits, to the first device 110, a second message comprising backoff information corresponding to one of the first feature and the first partition.

In some example embodiments, the backoff information may indicate a backoff indicator (BI) applicability per feature or per partition, and the BI is associated with a random access channel occasion for the plurality of features.

In some example embodiments, the backoff information is contained in the BI.

In some example embodiments, the second message may further comprise random access responses for the plurality of features, and the backoff information is placed after all the random access responses.

In some example embodiments, a presence of the backoff information is indicated by one of the following:
at least one reserved bit in a MAC subheader comprising the BI,
at least one reserved field in the second message, and
at least one field in the MAC subheader.

In some example embodiments, the second device 120 may transmit, to the first device 120, control information for scheduling the second message, and the control information may indicate the presence of the backoff information. For example, the control information may be DCI.

In some example embodiments, the backoff information may comprise a bitmap indicating BI applicability for one of the following:
each of the plurality of the features, and
at least one of the plurality of the features for which the backoff applies.

In some example embodiments, the backoff information may comprise a backoff indicator (BI) corresponding to one of the first feature and the first partition, and the second message may comprise a respective BI per feature or per partition.

In some example embodiments, the backoff information indicates at least one index of at least one partition for which the backoff applies.

In some example embodiments, the second device 120 may transmit, to the first device 110, a random access configuration comprising indexing information of the plurality of features.

In some example embodiments, indexing of the plurality of features is preconfigured by the second device based on one of the following:
an ascending order of preamble indexes for a random access channel, RACH, occasion for the plurality of features, each of the preamble indexes corresponding to a respective one of the plurality of features,
a descending order of the preamble indexes for the RACH occasion,
an ascending order of the plurality of features predetermined for the RACH occasion, and
a descending order of the plurality of features predetermined for the RACH occasion.

In some example embodiments, the first message may comprise a MSGA, and the second message may comprise a MSGB.

In some example embodiments, the first message may comprise a random access preamble, and the second message may comprise a random access response, RAR.

In some example embodiments, the second message may comprise control information for scheduling a response message for the first message.

In some example embodiments, the plurality of features may comprise at least one of coverage enhancement, small data transmission, reduced capability, and slicing.

In some example embodiments, the first device 110 may comprise a terminal device, and the second device 120 may comprise a network device.

According to the example embodiments, there is provided an adaptive backoff mechanism for RACH. Based on the backoff mechanism, the gNB is capable of indicating BI applicability per features or per RACH partitions. Additionally, or alternatively, the network is capable of indicating RACH partition specific BIs. Such a mechanism is suitable for a case where a RO with a common RACH applied by both the legacy UEs and the UEs supporting features and feature combination of RedCap, SDT, CovEnh, slicing, etc, and a case where a RO not shared with the common RACH. The UE can determine whether to apply backoff based on the BI applicability. As such, the efficiency of the RA procedure can be improved.

In some example embodiments, a first apparatus capable of performing any of the method 500 (for example, the first device 110) may comprise means for performing the respective steps of the method 500. The means may be implemented in any suitable form. For example, the means may be implemented in a circuitry or software module.

In some example embodiments, the first apparatus comprises: means for transmitting, to a second apparatus, a first message for requesting a first random access to a cell of the second apparatus, resources of the cell being partitioned into a plurality of partitions for a plurality of features, and the first random access associated with a first partition for at least a first feature of the plurality of features; and means for receiving, from the second apparatus, a second message comprising backoff information corresponding to one of the first feature and the first partition.

In some example embodiments, the backoff information indicating a backoff indicator, BI, applicability per feature or per partition, and the BI is associated with a random access channel occasion for the plurality of features.

In some example embodiments, the backoff information is contained in a MAC subheader comprising the BI.

In some example embodiments, the second message further comprises random access responses for the plurality of features, and the backoff information is placed after all the random access responses.

In some example embodiments, a presence of the backoff information is indicated by one of the following: at least one reserved bit in a MAC subheader comprising the BI, at least one reserved field in the second message, and at least one field in the MAC subheader.

In some example embodiments, the first apparatus further comprises: means for receiving, from the second apparatus, control information for scheduling the second message, the control information indicating the presence of the backoff information.

In some example embodiments, the backoff information comprises a bitmap indicating BI applicability for one of the following: each of the plurality of the features, and at least one of the plurality of the features for which the backoff applies.

In some example embodiments, the backoff information comprises a backoff indicator, BI, corresponding to one of the first feature and the first partition, and the second message comprises a respective BI per feature or per partition.

In some example embodiments, the backoff information indicates at least one index of at least one partition for which the backoff applies.

In some example embodiments, the first apparatus further comprises: means for receiving, from the second apparatus, a random access configuration comprising indexing information of the plurality of features.

In some example embodiments, indexing of the plurality of features is preconfigured by the second apparatus based on one of the following:
an ascending order of preamble indexes for a random access channel, RACH, occasion for the plurality of features, each of the preamble indexes corresponding to a respective one of the plurality of features,
a descending order of the preamble indexes for the RACH occasion,
an ascending order of the plurality of features predetermined for the RACH occasion, and
a descending order of the plurality of features predetermined for the RACH occasion.

In some example embodiments, the first apparatus further comprises: means for determining whether to apply backoff for a partition for the first feature based on the backoff information.

In some example embodiments, the first apparatus further comprises: means for in accordance with a determination that the backoff information indicates that a backoff is applicable to the partition, performing a backoff for the partition.

In some example embodiments, the first message comprises a MSGA and the second message comprises a MSGB.

In some example embodiments, the first message comprises a random access preamble and the second message comprises a random access response, RAR.

In some example embodiments, the second message comprises control information for scheduling a response message for the first message.

In some example embodiments, the plurality of features may comprise at least one of coverage enhancement, small data transmission, reduced capability, and slicing.

In some example embodiments, the first apparatus comprises a terminal device, and the second apparatus comprises a network device.

In some example embodiments, a second apparatus capable of performing any of the method 600 (for example, the second device 120) may comprise means for performing the respective steps of the method 600. The means may be implemented in any suitable form. For example, the means may be implemented in a circuitry or software module.

In some example embodiments, the second apparatus comprises: means for receiving, from a first apparatus, a first message for requesting a first random access to a cell of the second apparatus, resources of the cell being partitioned into a plurality of partitions for a plurality of features, and the first random access associated with a first partition for at least a first feature of the plurality of features; and transmitting, to the first apparatus, a second message comprising backoff information corresponding to one of the first feature and the first partition.

In some example embodiments, the backoff information indicating a backoff indicator, BI, applicability per feature or per partition, and the BI is associated with a random access channel occasion for the plurality of features.

In some example embodiments, the backoff information is contained in a MAC subheader comprising the BI.

In some example embodiments, the second message further comprises random access responses for the plurality of features, and the backoff information is placed after all the random access responses.

In some example embodiments, a presence of the backoff information is indicated by one of the following: at least one reserved bit in a MAC subheader comprising the BI, at least one reserved field in the second message, and at least one field in the MAC subheader.

In some example embodiments, the second apparatus further comprises: means for transmitting, to the first apparatus, control information for scheduling the second message, the control information indicating the presence of the backoff information.

In some example embodiments, the backoff information comprises a bitmap indicating BI applicability for one of the following: each of the plurality of the features, and at least one of the plurality of the features for which the backoff applies.

In some example embodiments, the backoff information comprises a backoff indicator, BI, corresponding to the one of the first feature and the first partition, and the second message comprises a respective BI per feature or per partition.

In some example embodiments, the backoff information indicates at least one index of at least one partition for which the backoff applies.

In some example embodiments, the second apparatus further comprises: means for transmitting, to the first apparatus, a random access configuration comprising indexing information of the plurality of features.

In some example embodiments, indexing of the plurality of features is preconfigured by the second apparatus based on one of the following:
an ascending order of preamble indexes for a random access channel, RACH, occasion for the plurality of features, each of the preamble indexes corresponding to a respective one of the plurality of features,
a descending order of the preamble indexes for the RACH occasion, an ascending order of the plurality of features predetermined for the RACH occasion, and
a descending order of the plurality of features predetermined for the RACH occasion.

In some example embodiments, the first message comprises a MSGA and the second message comprises a MSGB.

In some example embodiments, the first message comprises a random access preamble and the second message comprises a random access response, RAR.

In some example embodiments, the second message comprises control information for scheduling a response message for the first message.

In some example embodiments, the plurality of features may comprise at least one of coverage enhancement, small data transmission, reduced capability, and slicing.

In some example embodiments, the first apparatus comprises a terminal device, and the second apparatus comprises a network device.

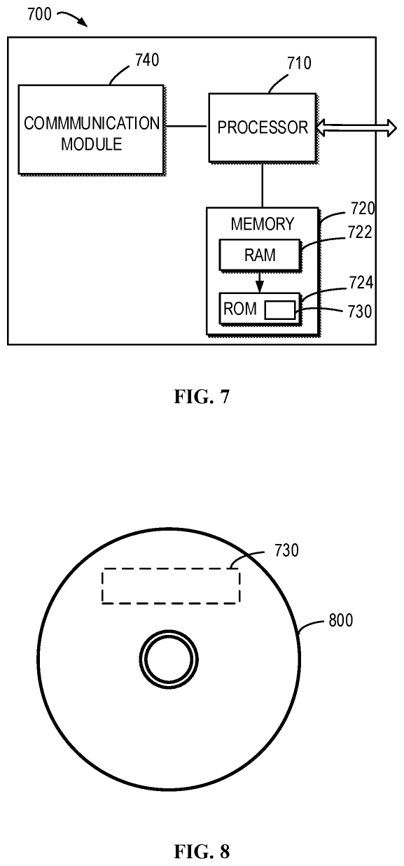

FIG. 7 is a simplified block diagram of a device 700 that is suitable for implementing embodiments of the present disclosure. The device 700 may be provided to implement the communication device, for example the first device 110 and the second device 120 as shown in FIG. 1. As shown, the device 700 includes one or more processors 710, one or more memories 720 coupled to the processor 710, and one or more transmitters and/or receivers (TX/RX) 740 coupled to the processor 710.

The TX/RX 740 may be configured for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 722 and other volatile memories that will not last in the power-down duration.

A computer program 730 includes computer executable instructions that may be executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIG. 2. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 5-6. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
the at least one memory and the computer program code being configured to, with the at least one processor, cause the first device at least to:
transmit, to a second device, a first message for requesting a first random access to a cell of the second device, resources of the cell being partitioned into a plurality of partitions for a plurality of features, and the first random access associated with a first partition for at least a first feature of the plurality of features; and
receive, from the second device, a second message comprising backoff information corresponding to one of the first feature or the first partition.

2. The first device of claim 1, wherein the backoff information indicating a backoff indicator, BI, applicability per feature or per partition, and the BI is associated with a random access channel occasion for the plurality of features.

3. The first device of claim 2, wherein the backoff information is contained in a MAC subheader comprising the BI.

4. The first device of claim 2, wherein the second message further comprises random access responses for the plurality of features, and the backoff information is placed after all the random access responses.

5. The first device of claim 4, wherein a presence of the backoff information is indicated by one of the following:
at least one reserved bit in a MAC subheader comprising the BI,
at least one reserved field in the second message, and
at least one field in the MAC subheader.

6. The first device of claim 4, wherein the at least one memory and the computer program code are configured to, with the at least one processor, further cause the first device to:
receive, from the second device, control information for scheduling the second message, the control information indicating the presence of the backoff information.

7. The first device of claim 1, wherein the backoff information comprises a bitmap indicating a backoff indicator, BI, applicability for one of the following:
each of the plurality of the features, and
at least one of the plurality of the features for which the backoff applies.

8. The first device of claim 1, wherein the backoff information comprises a backoff indicator, BI, corresponding to the one of the first feature and the first partition, and the second message comprises a respective BI per feature or per partition.

9. The first device of claim 1, wherein the backoff information indicates at least one index of at least one partition for which the backoff applies.

10. The first device of claim 9, wherein the at least one memory and the computer program code are configured to, with the at least one processor, further cause the first device to:
receive, from the second device, a random access configuration comprising indexing information of the plurality of features wherein indexing of the plurality of features is preconfigured by the second device based on one of the following:
an ascending order of preamble indexes for a random access channel, RACH, occasion for the plurality of features, each of the preamble indexes corresponding to a respective one of the plurality of features,
a descending order of the preamble indexes for the RACH occasion,
an ascending order of the plurality of features predetermined for the RACH occasion, and
a descending order of the plurality of features predetermined for the RACH occasion.

11. (canceled)

12. The first device of claim 1, wherein the at least one memory and the computer program codes are configured to, with the at least one processor, further cause the first device to:
determine whether to apply backoff for a partition for the first feature based on the backoff information; and
in accordance with a determination that the backoff information indicates that a backoff is applicable to the partition, perform a backoff for the partition.

13-17. (canceled)

18. A second device, comprising:
at least one processor; and
at least one memory including computer program code;
the at least one memory and the computer program codes being configured to, with the at least one processor, cause the second device at least to:
receive, from a first device, a first message for requesting a first random access to a cell of the second device, resources of the cell being partitioned into a plurality of partitions for a plurality of features, and the first random access associated with a first partition for at least a first feature of the plurality of features; and
transmit, to the first device, a second message comprising backoff information corresponding to one of the first feature or the first partition.

19. The second device of claim 18, wherein the backoff information indicating a backoff indicator, BI, applicability per feature or per partition, and the BI is associated with a random access channel occasion for the plurality of features.

20. The second device of claim 19, wherein the backoff information is contained in a MAC subheader comprising the BI.

21. The second device of claim 19, wherein the second message further comprises random access responses for the plurality of features, and the backoff information is placed after all the random access responses.

22. The second device of claim 21, wherein a presence of the backoff information is indicated by one of the following:
at least one reserved bit in a MAC subheader comprising the BI,
at least one reserved field in the second message, and
at least one field in the MAC subheader.

23. The second device of claim 21, wherein the at least one memory and the computer program code are configured to, with the at least one processor, further cause the second device to:
transmit, to the first device, control information for scheduling the second message, the control information indicating the presence of the backoff information.

24-32. (canceled)

33. A method comprising:
transmitting, at a first device and to a second device, a first message for requesting a first random access to a cell of the second device, resources of the cell being partitioned into a plurality of partitions for a plurality of features, and the first random access associated with a first partition for at least a first feature of the plurality of features; and
receiving, from the second device, a second message comprising backoff information corresponding to one of the first feature or the first partition.

34-37. (canceled)
